(19) United States
(12) Patent Application Publication
(10) Pub. No.: US 2008/0211438 A1
(43) Pub. Date: Sep. 4, 2008

(54) Fully Charged Battery Protection

(75) Inventors: Oliver A. Bell, Aiken, SC (US); Warren Clark, Evans, GA (US)

Correspondence Address: HARNESS, DICKEY & PIERCE, P.L.C., P.O. BOX 828, BLOOMFIELD HILLS, MI, 48303, US

(73) Assignee: TEXTRON INC., Providence, RI (US)

(21) Appl. No.: 11/681,365

(22) Filed: Mar. 2, 2007

(51) Int. Cl. H02P 3/14

(52) U.S. Cl. 318/376; 318/139

(57) ABSTRACT

A method for protecting against overcharging a battery of a light-weight utility vehicle during regenerative braking includes controlling a regenerative braking process such that a predetermined activation amount of braking torque is produced by a motor of the vehicle when braking torque within a full braking range is initially requested. The predetermined activation amount of braking torque is less than the full braking range. The method additionally includes reading a voltage across a battery of the vehicle induced by a current generated by the motor as the activation amount of braking torque is produced. The method further includes increasing the amount of braking torque produced by the motor, if the voltage across the battery is less than a specified battery voltage threshold.

### FIELD

The present teachings relate to regenerative braking control methods and systems for light-weight utility vehicles.

### BACKGROUND

The statements in this section merely provide background information related to the present disclosure and may not constitute prior art.

A least some known light-weight utility vehicles, such as small cargo/maintenance vehicles, shuttle vehicles or golf cars, include AC drive systems adapted to recapture energy spent for acceleration and driving of electric vehicles. Particularly, kinetic energy is converted back into electrical energy and put back into the one or more batteries of the vehicle by the generator action of the AC motor while the vehicle is decelerating. This is sometimes referred to as regenerative braking. The AC motor acts as an alternator and produces voltages high enough, even at low RPMs, to supply charging current to the batteries. Typically, a vehicle motor controller, e.g., microcontroller, controls the amount of current produced by the motor and, thus, the amount of voltage generated by the motor. Although returning energy to the batteries is useful in getting extended vehicle range between battery charges and keeping the batteries well charged, a problem occurs when a battery is fully charged and extra current is applied to it.

If a battery is fully charged, the current generated by the motor during regenerative braking will cause the battery voltage to rise to values too high for various electronics associated with the regenerative charging system to handle, i.e., the motor controller, and failures are likely to occur. Additionally, voltages that exceed the rated voltage of a battery can affect the life of the battery. Reducing the voltage to safer levels by producing less current will lower the charging voltage; however, when the current is produced by regenerative braking, the braking torque of the motor must also be reduced. This could result in loss of sufficient braking when traveling down a long, steep hill.

In known AC motor controllers, it is possible to increase and decrease braking torque quickly. However, if the battery is fully charged, the inherent delays introduced in the sampling rates of the controllers may be long enough to allow regenerated current to damage electronic systems before the ‘over-voltage’ is detected by the controller and the braking torque is reduced. Hardware comparators can be used to increase the speed at which an over-voltage is detected. However, when hardware comparators detect an over-voltage, the over-voltage is treated as a fault. In response to such faults, the controller generally commands an emergency shutdown, resulting in an immediately locking braking system.

### SUMMARY

A method for protecting against overcharging a battery of a light-weight utility vehicle during regenerative braking is provided. In various embodiments, the method includes controlling a regenerative braking process such that a predetermined activation amount of braking torque is produced by a motor of the vehicle when braking torque within a full braking range is initially requested. The predetermined activation amount of braking torque is less than the full braking range. The method additionally includes reading a voltage across a battery of the vehicle induced by a current generated by the motor as the activation amount of braking torque is produced. The method further includes increasing the amount of braking torque produced by the motor, if the voltage across the battery is less than a specified battery voltage threshold.

In various embodiments, the method can further include decreasing the amount of braking torque produced by the motor, if the voltage across the battery is greater than the specified battery voltage threshold. In various embodiments, the method can still further include maintaining the amount of braking torque produced by the motor if the voltage across the battery is above the specified battery voltage threshold.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a side view of a light-weight utility vehicle including a battery overcharging protection system, in accordance with various embodiments of the present disclosure;

FIG. 2 is a block diagram of the battery overcharging protection system, shown in FIG. 1, in accordance with various embodiments; and

FIG. 3 is a flow chart illustrating the operation of the battery overcharging protection system, shown in FIG. 1, in accordance with various embodiments.

### DETAILED DESCRIPTION

The following description is merely exemplary in nature and is in no way intended to limit the present teachings, application, or uses. Throughout this specification, like reference numerals will be used to refer to like elements.

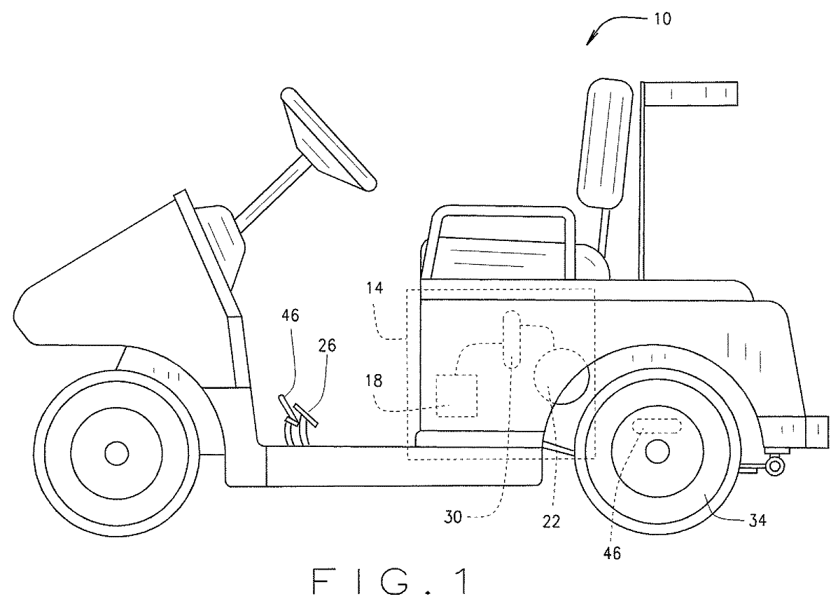

FIG. 1 illustrates a light-weight utility vehicle 10, such as a small cargo/maintenance vehicle, a shuttle vehicle or a golf car, that includes a battery overcharging protection system 14, in accordance with various embodiments of the present disclosure. The light-weight utility vehicle 10 can include one or more batteries 18 that supply electrical power to operate various components and subsystems of the vehicle 10. Particularly, the one or more batteries 18 are used to provide power to operate, or drive, an electric motor 22, e.g., an induction motor, that generates motive force for the vehicle 10. In various embodiments, the vehicle 10 can include a single battery 18 to provide the necessary electrical power, while in other embodiments, the vehicle 10 can include two or more batteries 18 connected in parallel to provide the necessary electrical power. Thus, although, the vehicle 10 can include one or more batteries 18, for clarity and simplicity, the present disclosure will describe the vehicle 10 and the battery overcharging protection system 14 in terms of a single battery 18.

The vehicle 10 incorporates regenerative braking to slow and/or stop the vehicle. That is, during a braking operation of the vehicle 10, e.g., when an operator depresses a brake pedal 26 to slow or stop the vehicle 10, the motor 22, e.g., an induction motor, generates reverse torque within the motor 22 to slow and/or stop the vehicle 10. In various embodiments wherein the motor 22 comprises an induction motor, regenerative braking is generally accomplished by supplying a rotating stator vector that lags the rotational rotor vector produced by the motor as it turns. This results in the motor 22 producing, or generating, alternating current. Controller electronics, e.g., diodes and transistor switches (not shown), of a motor controller 30 rectify the alternating current into direct current that is applied to the battery 18. The battery 18 acts as a low impedance load to the controller 30, which absorbs braking energy during braking, providing a means to generate motor braking torque. The motor 18 is directly coupled to drive wheels 34 through reduction gearing (not shown), such that the negative, or braking, torque is applied to the drive wheels 34 of the vehicle 10. Additionally, the direct current applied to the battery 18 is used to recharge the battery 18. However, if the battery 18 is fully, or nearly fully, charged, the battery 18 can not accept more current. Thus, the regenerative braking can damage the battery 18 and/or the electronics of the motor controller 30 if the battery 18 is fully, or nearly fully, charged.

The battery overcharging protection system 14 effectively prevents such overcharging of the battery 18 by limiting the initial amount of regenerative braking applied when an operator fully depresses the brake pedal 26 to apply full or maximum braking, also referred to herein as 100% braking, as described below. In various embodiments, the battery overcharging protection system 14 includes the battery 18, the motor 22 and the motor controller 30 that is electrically and communicatively connected to the battery and motor 18 and 22. As described below, in various embodiments, the controller 30 controls the motor 22 during an acceleration operation and a braking operation, and monitors a voltage across the battery 18

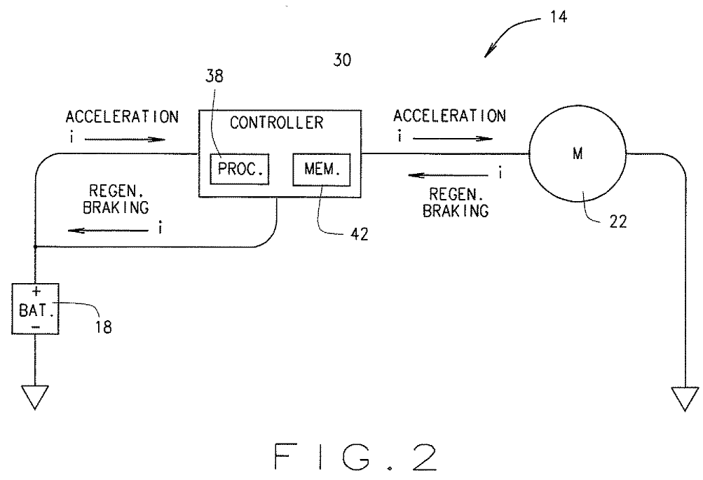

Referring now to FIG. 2, in addition to the controller electronics listed above, the motor controller includes at least one processor 38, e.g., a microprocessor, and at least one electronic memory device 42. The processor 38 can be any suitable processor for executing all functions of the battery overcharging protection system 14. For example, in various embodiments, the processor 38 executes a battery overcharging protection algorithm stored on the memory device 42. Execution of the battery overcharging protection algorithm controls operation of the battery overcharging protection system 14, as described herein. The memory device 42 can be any suitable computer readable medium for storing such things as data, information, software programs and algorithms that are used or executed by the processor 38 during operation of the battery overcharging protection system 14. During the acceleration operation of the vehicle 10, depression of an accelerator pedal 46 (shown in FIG. 1) communicates an acceleration signal to the controller 30. The controller 30, i.e., the processor 38, processes the acceleration signal and controllably provides current from the battery 18 to the motor 22 to generate drive torque to accelerate the vehicle 10.

Similarly, during the braking operation, depression of the brake pedal 26 communicates a braking signal, i.e., a braking request, to the controller 30. The controller 30 processes the braking signal and commands the stator vector to lag the rotor vector by a specific amount and thereby providing regenerative braking torque, i.e., regenerative braking. The amount of regenerative current produced by the motor 22 during regenerative braking is proportional to the amount of commanded lag of the stator vector. Additionally, the amount of commanded lag is generally proportional to the amount of depression of the brake pedal 26. Thus, in most instances, the battery overcharging protection system 14 operates such that the greater the amount of depression of the brake pedal 26, the greater the amount of regenerative torque and regenerative current that is produced by the motor 22.

More particularly, in various embodiments, the battery overcharging protection system 14 operates such that when the brake pedal 26 is depressed to a position that does not request an amount of regenerative braking within a predetermined full or maximum braking range, the battery overcharging protection system 14 and controller 30 operate to command regenerative braking that is proportional to the amount of depression of the brake pedal 26, as described above. For example, if the brake pedal 26 is depressed to a position that requests 50% or less of the maximum regenerative braking potential, the battery overcharging protection system 14 and controller operate to command regenerative braking proportional to the amount of brake pedal depression, i.e., 50% or less. Regenerative braking within the predetermined full or maximum braking range, e.g., greater than 50% braking, will sometimes be referred to herein as ‘full range braking’.

However, if full range braking is requested, the battery overcharging protection system 14 operates such that the controller 30 does not initially command regenerative braking proportional to the amount of brake pedal 26 depression. Rather, when full range braking is requested, e.g., greater than 50% braking, the battery overcharging protection system 14 operates such that the controller 30 initially commands a predetermined activation amount that is less than the requested amount of braking, e.g., 50%, of maximum braking. The controller 30 then checks the voltage level across the battery 18. If the voltage level across the battery 18 does not exceed a predetermined maximum voltage threshold, the controller commands a predetermined amount of increase in the amount of regenerative braking torque produced by the motor 22. For example, the controller commands that the regenerative braking torque be increased by 5% from the activation amount.

The controller 30 then checks the voltage level across the battery 18 after the increment again. If the voltage level across the battery 18 still does not exceed the predetermined maximum voltage threshold, the controller 30 commands another increase in the amount of regenerative braking torque produced by the motor 22. The controller 30 continues to check the voltage across the battery 18 and increase the amount of commanded regenerative braking if the battery voltage does not exceed the voltage threshold. This continues, until the amount of regenerative braking commanded by the controller 30 approximately equals the amount of requested braking torque. Thus, the battery overcharging protection system 14 effectively prevents the possibility of overcharging the battery 18 and damaging the battery 18 and/or the controller 30.

If at any point, the voltage across the battery 18 equals or exceeds the voltage threshold, the controller 30 commands the motor 22 to maintain or decrease the amount of regenerative braking. The controller 30 then, again checks the battery voltage, and if the voltage across the battery is less than the voltage threshold, the controller 30 commands an increase in the amount of regenerative braking produced. But, if the voltage across the battery 18 still equals, or exceeds, the voltage threshold, the controller 30 again commands the motor 22 to maintain or decrease the amount of regenerative braking produced. Thus, during the braking operation, the controller 30 continuously monitors the voltage across the battery 18. In response to the battery 18 voltage readings, the controller 30 incrementally adjusts the amount of regenerative braking produced by the motor 22 to achieve the requested amount regenerative braking. Thus, the battery overcharging protection system 14 provides the requested amount of regenerative braking without producing amounts of regenerative current that will cause the voltage across the battery 18 to exceed the voltage threshold.

In various embodiments, the interrupt speed of the processor 38 is such that when full range braking is requested, the controller 30 initially applies the activation amount of regenerative braking, reads the battery 18 voltage and appropriately adjusts the amount of regenerative braking within a few milliseconds. For example, the interrupt speed of the processor 38 can be approximately 10 to 20 milliseconds. Likewise, the controller 30 re-checks the battery 18 voltage and appropriately adjusts the amount of regenerative braking, as described above, every few milliseconds, e.g., every 10 to 20 milliseconds. Therefore, the battery overcharging protection system 14 operates such that when full range braking is requested, the requested amount of full range regenerative braking is effectively produced within a very short time. For example, the battery overcharging protection system 14 can provide approximately the amount of full range regenerative braking requested within approximately 0.100 seconds or less.

The full braking range can be specified to be any range in which application of the requested braking amount might produce amounts of regenerative current that will produce voltage levels across the battery 18 that exceed the predetermined voltage threshold. For example, in various embodiments, the full braking range can equal approximately 50% to 100% of the maximum regenerative braking potential of the motor 22. Additionally, the predetermined voltage threshold can be any desirable voltage level that does not exceed the rated voltage of the battery 18. For example, in various embodiments, the voltage threshold is specified to be 120% to 125% of the rated voltage of the battery 18. For instance, if the rated voltage of the battery 18 is 60 volts, the voltage threshold can be 58 to 59 volts. Furthermore, the activation amount of regenerative braking can be any amount suitable that will not produce regenerative current that induces a voltage across the battery 18 in excess of the threshold voltage. For example, in various embodiments, the activation amount of regenerative braking is 30% to 70%, e.g., 50%, of the making regenerative braking potential of the motor 22.

In various embodiments, the battery overcharging protection system 14 also operates to protect against overcharging the battery 18 during normal operation of the vehicle 10, that is, during less than full braking situations. In such embodiments, the controller 30 substantially constantly monitors the voltage across the battery 18. If any requested braking amount will produce voltages across the battery 18 in excess of the voltage threshold, the controller 30 will reduce the amount regenerative braking produced to a level that will not overcharge the battery 18. The controller 30 will subsequently attempt to increase the amount of regenerative braking to achieve the requested amount without exceeding the voltage threshold, as described above. If at any point, the amount of regenerative braking commanded by the controller 30 can not be increased to approximately equal the requested amount of braking, within a predetermined time period, e.g., 0.100 seconds, the controller 30 will activate a secondary braking system to slow and/or stop the vehicle 10.

For example, if the battery 18 is fully charged, or nearly fully charged, and the vehicle 10 is rolling down a long, steep hill, regenerative braking torque of at least 80% may be required to keep the vehicle from running away. However, since the battery 18 is fully charged, extended braking at 80% may produce enough regenerative current to induce a voltage across the battery 18 in excess of the voltage threshold. The controller 30 will substantially instantaneously decrease the amount of regenerative braking to avoid overcharging the battery 18. For example, the controller 30 may reduce the amount of regenerative braking to 50%, and then attempt to increment the amount of regenerative braking back up to 80%, as described above. However, since the vehicle 10 is traveling down a long, steep hill, 80% braking may not be achievable without exceeding the voltage threshold, and less than 80% braking will be insufficient to slow and/or stop the vehicle 10 as desired. Accordingly, the battery overcharging protection system 14 will operate such that the controller 30 activates the secondary braking system to assist the regenerative braking system in slowing and/or stopping the vehicle 10. For example, in various embodiments, the controller 30 commands a pulsing of a secondary braking system 50 (shown in FIG. 1), e.g., a parking brake system, to assist the regenerative braking system in slowing and/or stopping the vehicle 10.

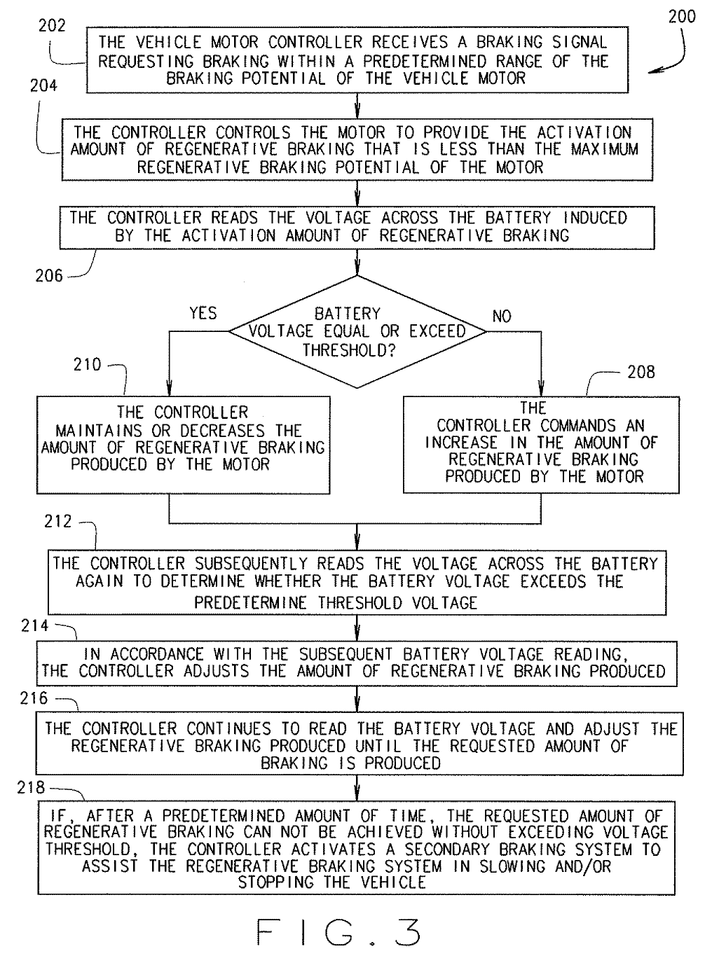

Referring now to FIG. 3, a flow chart 200, illustrating the operation of the battery overcharging protection system 14 is provided. When the brake pedal 26 is depressed to apply full range braking, the controller 30 receives the braking signal requesting full range braking, as indicated at 202. Upon receipt of the full range braking signal, the controller 30 induces a lagging stator vector in the motor 22 that generates the activation amount of regenerative braking, wherein the activation amount is less than the maximum regenerative braking potential of the motor 22, as indicated at 204. The controller 30 then reads the voltage across the battery 18 induced by the activation amount of regenerative braking, as indicated at 206. If the battery 18 voltage induced by the activation amount of regenerative braking is less than the predetermined threshold voltage, the controller 30 commands an increase in the amount of regenerative braking produced by the motor 22, as indicated at 208.

However, if the battery 18 voltage induced by the activation amount of regenerative braking is equal to or greater than the predetermined threshold voltage, the controller 30 maintains or decreases the amount of regenerative braking produced by the motor 22, as indicated at 210. The controller 30 subsequently then reads the voltage across the battery 18 again to determine whether the battery 18 voltage exceeds that predetermined threshold voltage, as indicated at 212. In accordance with the subsequent battery 18 voltage reading, the controller 30 adjusts the amount of regenerative braking produced, i.e., increases or decreases the amount of regenerative braking produced, as indicated at 214. The controller 30 continues to read the battery 18 voltage and adjust the regenerative braking produced by the motor 22 accordingly, until the requested amount of braking is produced, as indicated at 216. If, after a predetermined amount of time, the requested amount of regenerative braking can not be achieved without exceeding voltage threshold, the controller 30 activates a secondary braking system to assist the regenerative braking system in slowing and/or stopping the vehicle 10, as indicated at 218.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A method for protecting against overcharging a battery of a light-weight utility vehicle during regenerative braking, said method comprising:
controlling a regenerative braking process such that a predetermined activation amount of braking torque is produced by a motor of the vehicle when braking torque within a full braking range is initially requested, the predetermined activation amount of braking torque being less than the full braking range;
reading a voltage across a battery of a light-weight utility vehicle induced by current generated by the motor as the activation amount of braking torque is produced; and
increasing the amount of braking torque produced by the motor if the voltage across the battery is less than a predetermined battery voltage threshold.

2. The method of claim 1, further comprising decreasing the amount of braking torque produced by the motor if the voltage across the battery is greater than the battery voltage threshold.

3. The method of claim 1, further comprising maintaining the amount of braking torque produced by the motor if the voltage across the battery is greater than the battery voltage threshold.

4. The method of claim 1, further comprising:
substantially continuously monitoring the voltage across the battery during the regenerative braking process; and
substantially continuously adjusting the amount of braking torque produced by the motor to maintain the voltage across the battery above the battery voltage threshold.

5. The method of claim 2, further comprising activating a secondary braking system if the voltage across the battery is greater than the battery voltage threshold and the braking torque produced has been decreased to less than the activation amount of braking torque and greater than the activation amount of braking torque is being requested.

6. The method of claim 1, wherein the activation amount of braking torque comprises between approximately 30% and 70% of the full braking torque.

7. The method of claim 1, wherein the predetermined battery voltage is between approximately 120% and 125% of a rated voltage of the battery.

8. A light-weight utility vehicle, said vehicle comprising:
a controller for controlling a regenerative braking process of the vehicle, the controller is configured to:
control a motor of the vehicle such that a predetermine activation amount of braking torque is produced by the motor when braking torque within a full braking range is initially requested, the predetermined activation amount of braking torque being less than the full braking range;
read a voltage across a battery of a light-weight utility vehicle induced by current generated by the motor as the activation amount of braking torque is produced; and
increase the amount of braking torque produced by the motor if the voltage across the battery is less than a predetermined battery voltage threshold.

9. The vehicle of claim 8, wherein the controller is further configured to decrease the amount of braking torque produced by the motor if the voltage across the battery is greater than the battery voltage threshold.

10. The vehicle of claim 8, wherein the controller is further configured to maintain the amount of braking torque produced by the motor if the voltage across the battery is above the battery voltage threshold.

11. The vehicle of claim 8, wherein the controller is further configured to:
substantially continuously monitor the voltage across the battery during the regenerative braking process; and
substantially continuously adjust the amount of braking torque produced by the motor to maintain the voltage across the battery above the battery voltage threshold.

12. The vehicle of claim 9, wherein the controller is further configured to activate a secondary braking system if the voltage across the battery is greater than the battery voltage threshold and the braking torque produced has been decreased to less than the activation amount of braking torque and greater than the activation amount of braking torque is requested.

13. The vehicle of claim 8, wherein the torque activation amount of braking torque comprises between approximately 30% and 70% of the full braking torque.

14. The vehicle of claim 8, wherein the predetermined battery voltage threshold is between approximately 120% and 125% of a rated voltage of the battery.

15. A method for protecting against overcharging a battery of a light-weight utility vehicle during regenerative braking, said method comprising:
controlling a regenerative braking process such that a predetermined activation amount of braking torque is produced by a motor of the vehicle when braking torque within a full braking range is initially requested, the predetermined activation amount of braking torque being less than the full braking range;
reading a voltage across a battery of a light-weight utility vehicle induced by current generated by the motor as the activation amount of braking torque is produced;
increasing the amount of braking torque produced by the motor if the voltage across the battery is less than a predetermined battery voltage threshold;
decreasing the amount of braking torque produced by the motor if the voltage across the battery is greater than the battery voltage threshold; and
maintaining the amount of braking torque produced by the motor if the voltage across the battery is above the battery voltage threshold.

16. The method of claim 15, further comprising:
substantially continuously monitoring the voltage across the battery during the regenerative braking process; and
substantially continuously adjusting the amount of braking torque produced by the motor to maintain the voltage across the battery above the battery voltage threshold.

17. The method of claim 15, further comprising activating a secondary braking system if the voltage across the battery is greater than the battery voltage threshold and the braking torque produced has been decreased to less than the activation amount of braking torque and greater than the activation amount of braking torque is requested.

18. The method of claim 15, wherein the torque activation amount of braking torque comprises between approximately 30% and 70% of the full braking torque.

19. The method of claim 15, wherein the predetermined battery voltage threshold is between approximately 120% and 125% of a rated voltage of the battery.
